(19) United States
(12) Patent Application Publication
(10) Pub. No.: US 2026/0189894 A1
(43) Pub. Date: Jul. 2, 2026

(54) METHODS, SYSTEMS, AND COMPUTER READABLE MEDIA FOR AUTOMATICALLY DERIVING AND USING STEERING OF ROAMING POLICIES

(71) Applicant: Oracle International Corporation, Redwood Shores, CA (US)

(72) Inventors: Shashikiran Bhalachandra Mahalank, Bangalore (IN); Virendra Singh, Bangalore (IN); Jay Rajput, Bangalore (IN)

(21) Appl. No.: 19/006,130

(22) Filed: Dec. 30, 2024

(51) Int. Cl. H04W 8/02; H04W 16/18; H04W 84/04

(52) U.S. Cl. CPC H04W 8/02; H04W 16/18; H04W 84/042

(57) ABSTRACT

A method for automatically deriving and using a steering of roaming policy includes learning a steering of roaming (SoR) policy of a home public land mobile network (HPLMN). The method further includes receiving, by a proxy function, an SBI message from a first VPLMN and relating to an outbound roaming subscriber. The method further includes determining, by the proxy function and using the SoR policy for the HPLMN and parameters from the SBI message, whether the SoR policy indicates that the HPLMN will steer the outbound roaming subscriber to a VPLMN other than the first VPLMN. The method further includes blocking, by the proxy function, the SBI message when the SoR policy indicates that the HPLMN will steer the outbound roaming subscriber to a VPLMN other than the first VPLMN.

### TECHNICAL FIELD

The subject matter described herein relates to policy control in communications networks. More particularly, the subject matter described herein relates to methods, systems, and computer readable media for automatically deriving and using steering of roaming policies.

### BACKGROUND

In 5G telecommunications networks, a network function that provides service is referred to as a producer network function (NF) or NF service producer. A network function that consumes services is referred to as a consumer NF or NF service consumer. A network function can be a producer NF, a consumer NF, or both, depending on whether the network function is consuming, producing, or consuming and producing services. The terms “producer NF” and “NF service producer” are used interchangeably herein. Similarly, the terms “consumer NF” and “NF service consumer” are used interchangeably herein.

A given producer NF may have many service endpoints, where a service endpoint is the point of contact for one or more NF instances hosted by the producer NF. The service endpoint is identified by a combination of Internet protocol (IP) address and port number or a fully qualified domain name (FQDN) that resolves to an IP address and port number on a network node that hosts a producer NF. An NF service instance is a service instance of a producer NF that provides one or more services. A given producer NF may include more than one NF service instance. It should also be noted that multiple NF service instances can share the same service endpoint.

NFs register with an NF repository function (NRF). The NRF maintains profiles of available NF instances identifying the services supported by each NF instance. The profile of an NF instance is referred to in 3GPP TS 29.510 as an NF profile. NF instances can obtain information about other NF instances that have registered with the NRF through the NF discovery service operation. According to the NF discovery service operation, a consumer NF sends an NF discovery request to the NRF. The NF discovery request includes query parameters that the NRF uses to locate the NF profiles of producer NFs capable of providing the service identified by the query parameters. NF profiles are data structures that define the types of services provided by an NF instance as well as contact and capacity information regarding the NF instance.

Service communication proxies (SCPs) route messages between NF instances. An SCP can also invoke the NF discovery service operation to learn about available NF instances. The case where the SCP uses the NF discovery service operation to obtain information about producer NF instances on behalf of consumer NFs is referred to as delegated discovery. Consumer NFs connect to the SCP, and the SCP load balances traffic among producer NF service instances that provide the required services or directly routes the traffic to the destination producer NF instance.

Another type of proxy function defined for 5G network is the security edge protection proxy (SEPP). A SEPP filters traffic entering and leaving a public land mobile network (PLMN).

One problem that can occur in communication networks is that outbound roaming subscribers can be steered by a home public land mobile network (HPLMN) to attach to a preferred visited PLMN (VPLMN) of the HPLMN, and non-preferred VPLMN may lack visibility as to the steering of roaming policy of the HPLMN, resulting in unnecessary signaling an lost revenue. For example, a mobile subscriber whose UE attaches to the VPLMN may send a registration request to the HPLMN. The HPLMN may receive the registration request, determine that the UE is attempting to register with the non-preferred VPLMN, and signal with the UE to direct the UE to register with a preferred VPLMN. The signaling with the UE to direct the UE to register with another PLMN other than the PLMN in which the UE is currently located is referred to as steering of roaming. In such a scenario, the non-preferred VPLMN signals unnecessarily with the HPLMN and loses revenue associated with managing communications with the UE because the UE registers with another network. The signaling performed by the non-preferred VPLMN prior to the UE registering with the preferred VPLMN also wastes network resources.

In light of these and other difficulties, there exists a need for improved methods, systems, and computer readable media for automatically deriving and using steering of roaming policies.

### SUMMARY

A method for automatically deriving and using a steering of roaming policy includes learning a steering of roaming policy (SoR) of a home public land mobile network (HPLMN). The method further includes receiving, by a proxy function, an SBI message from a first visited public land mobile network (VPLMN) and relating to an outbound roaming subscriber. An outbound roaming subscriber is a subscriber of an HPLMN who is attempting to register with a PLMN other than the HPLMN. The method further includes determining, by the proxy function and using the SoR policy of the HPLMN and parameters from the SBI message, whether the policy indicates that the HPLMN will steer the outbound roaming subscriber to a VPLMN other than the first VPLMN. The method further includes blocking, by the proxy function, the SBI message when the policy indicates that the HPLMN will steer the outbound roaming subscriber to a VPLMN other than the first VPLMN.

In one example, the proxy function is located in the first VPLMN. In another example, the proxy function may be located in the network of a roaming hub (RH) or Internet protocol (IP) exchange (IPX) provider.

According to another aspect of the subject matter described herein, learning the SoR policy of the HPLMN includes learning the SoR policy from SBI message feeds from the HPLMN.

According to another aspect of the subject matter described herein, learning the SoR policy includes training a machine learning model to predict whether an outbound roaming subscriber will be steered to a VPLMN other than the first VPLMN.

According to another aspect of the subject matter described herein, learning the SoR policy used by the HPLMN includes learning the SoR policy at a network analytics platform.

According to another aspect of the subject matter described herein, determining, by the proxy function whether the SoR policy indicates that the HPLMN will steer the outbound roaming subscriber to a VPLMN other than the first VPLMN includes querying, by the proxy function, the network analytics platform and receiving a response from the network analytics platform indicating whether or not the outbound roaming subscriber will be steered to a VPLMN other than the first VPLMN.

According to another aspect of the subject matter described herein, learning the SoR policy at the network analytics platform includes learning the SoR policy at a network data analytics function (NWDAF).

According to another aspect of the subject matter described herein, learning the SoR policy at the network analytics platform includes learning the SoR policy at a stand-alone network analytics platform or at an analytics platform that is integrated or co-located with a network function.

According to another aspect of the subject matter described herein, learning the SoR policy at the analytics platform includes learning the SoR policy using a training dataset that includes data indicating numbers of UEs steered to particular VPLMNs, radio access types, time parameters, UE identifying parameters, network slice identifying parameters, network identifying parameters, UE locations, and corresponding SoR decisions.

According to another aspect of the subject matter described herein, the proxy function comprises a service communication proxy (SCP).

According to another aspect of the subject matter described herein, the proxy function comprises a security edge protection proxy (SEPP).

According to another aspect of the subject matter described herein, a system for automatically deriving and using a steering of roaming (SoR) policy is provided. The system includes an SoR policy determiner/results communicator for learning an SoR policy of a home public land mobile network (HPLMN). The system further includes a proxy function including at least one processor and a memory for receiving an SBI message from a first visited public land mobile network (VPLMN) and relating to an outbound roaming subscriber, determining, using the SoR policy for the HPLMN and parameters from the SBI message, whether the SoR policy indicates that the HPLMN will steer the outbound roaming subscriber to a VPLMN other than the first VPLMN, and blocking the SBI message when the SoR policy indicates that the HPLMN will steer the outbound roaming subscriber to a VPLMN other than the first VPLMN.

According to another aspect of the subject matter described herein, the SoR policy determiner/results communicator is configured to learn the SoR policy from SBI message feeds from the HPLMN.

According to another aspect of the subject matter described herein, the SoR policy determiner/results communicator is configured to learn the SoR policy by training a machine learning model to predict whether an outbound roaming subscriber will be steered to a VPLMN other than the first VPLMN.

According to another aspect of the subject matter described herein, the system includes a network analytics platform wherein the SoR policy determiner/results communicator is implemented on the network analytics platform.

According to another aspect of the subject matter described herein, the proxy function is configured to determine whether the SoR policy indicates that the HPLMN will steer the outbound roaming subscriber to a VPLMN other than the first VPLMN by querying the network analytics platform and receiving a response from the network analytics platform indicating whether or not the outbound roaming subscriber will be steered to a VPLMN other than the first VPLMN.

According to another aspect of the subject matter described herein, the network analytics platform comprises a network data analytics function (NWDAF).

According to another aspect of the subject matter described herein, the network analytics platform comprises a stand-alone network analytics platform or a platform that is integrated or co-located with a network function.

According to another aspect of the subject matter described herein, the proxy function is configured to learn the SoR policy using a training dataset that includes data indicating numbers of UEs steered to particular VPLMNs, radio access types, time parameters, UE identifying parameters, network slice identifying parameters, network identifying parameters, UE locations, and corresponding SoR decisions.

According to another aspect of the subject matter described herein, the proxy function comprises a service communication proxy (SCP) or a security edge protection proxy (SEPP).

According to another aspect of the subject matter described herein, a non-transitory computer readable medium having stored thereon executable instructions that when executed by a processor of a computer control the computer to perform steps is provided. The steps include learning a steering of roaming (SoR) policy of a home public land mobile network (HPLMN). The steps further include receiving, by a proxy function, an SBI message from a first visited public land mobile network and relating to an outbound roaming subscriber. The steps further include determining, by the proxy function and using the SoR policy of the HPLMN and parameters from the SBI message, whether the SoR policy indicates that the HPLMN will steer the outbound roaming subscriber to a VPLMN other than the first VPLMN. The steps further include blocking, by the proxy function, the SBI message when the SoR policy indicates that the HPLMN will steer the outbound roaming subscriber to a VPLMN other than the first VPLMN.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer-readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating an exemplary 5G system network architecture;

FIG. 2 is a message flow diagram illustrating exemplary messages exchanged for performing steering of roaming during initial UE registration;

FIG. 3 is a message flow diagram illustrating exemplary messages exchanged for steering of roaming after initial UE registration;

FIG. 4 is a network diagram illustrating an exemplary architecture for automatically deriving and using a steering of roaming policy;

FIG. 5 is a block diagram illustrating an exemplary architecture of a network analytics platform and a proxy function for automatically deriving and using a steering of roaming policy; and

FIG. 6 is a flow chart illustrating an exemplary process for automatically deriving and using a steering of roaming policy.

### DETAILED DESCRIPTION

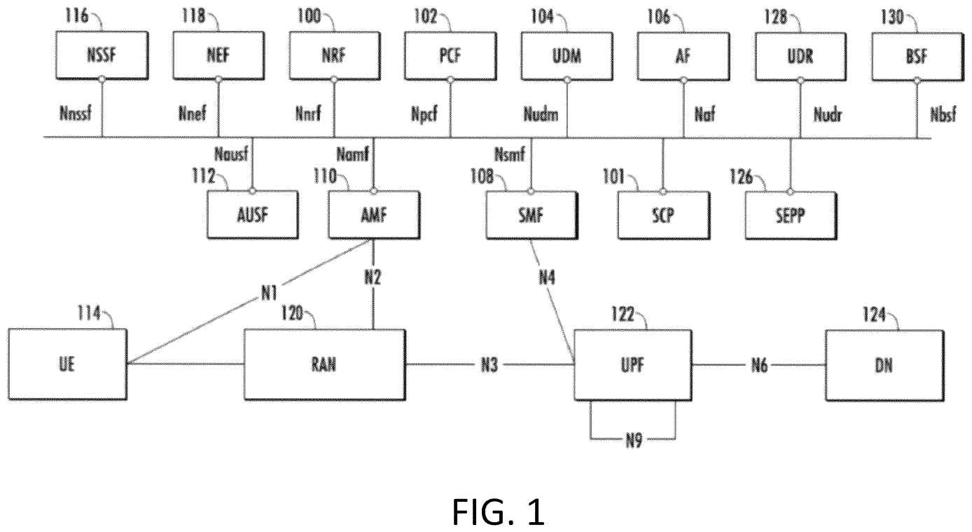

FIG. 1 is a network diagram illustrating an exemplary 5G system network architecture. The architecture in FIG. 1 includes NRF 100 and SCP 101, which may be located in the same home public land mobile network (HPLMN). As described above, NRF 100 may maintain profiles of available NF instances and their supported services and allow consumer NFs or SCPs to subscribe to and be notified of the registration of new/updated NF instances. SCP 101 may also support service discovery and selection of NF instances. SCP 101 may perform load balancing of connections between consumer and producer NFs.

NRF 100 is a repository for profiles of NF instances. To communicate with a producer NF instance, a consumer NF or an SCP must obtain the NF profile of the producer NF instance from NRF 100. The NF profile is a JavaScript object notation (JSON) data structure defined in 3GPP TS 29.510. The NF profile includes attributes that indicate the types of services provided, capacity of the NF instance, and information for contacting the NF instance.

In FIG. 1, any of the network functions can be consumer NFs, producer NFs, or both, depending on whether they are requesting, providing, or requesting and providing services. In the illustrated example, the NFs include a policy control function (PCF) 102 that performs policy related operations in a network, a unified data management function (UDM) 104 that manages user data, and an application function (AF) 106 that provides application services.

The NFs illustrated in FIG. 1 further include a session management function (SMF) 108 that manages sessions between an access and mobility management function (AMF) 110 and PCF 102. AMF 110 performs mobility management operations similar to those performed by a mobility management entity (MME) in 4G networks. An authentication server function (AUSF) 112 provides authentication services for user equipment (UEs), such as user equipment (UE) 114, seeking access to the network.

A network slice selection function (NSSF) 116 provides network slicing services for devices seeking to access specific network capabilities and characteristics associated with a network slice. NSSF 116 provides the NSSelection service, which allows NFs to request information about network slices and the NSSAIReachability service, which enables NFs to update and subscribe to receive notification of updates in network slice selection assistance information (NSSAI) reachability information.

A network exposure function (NEF) 118 provides application programming interfaces (APIs) for application functions seeking to obtain information about Internet of things (IoT) devices and other UEs attached to the network. NEF 118 performs similar functions to the service capability exposure function (SCEF) in 4G networks.

A radio access network (RAN) 120 connects user equipment (UE) 114 to the network via a wireless link. Radio access network 120 may be accessed using a gNB (not shown in FIG. 1) or other wireless access point. A user plane function (UPF) 122 can support various proxy functionality for user plane services. One example of such proxy functionality is multipath transmission control protocol (MPTCP) proxy functionality. UPF 122 may also support performance measurement functionality, which may be used by UE 114 to obtain network performance measurements. Also illustrated in FIG. 1 is a data network (DN) 124 through which UEs access data network services, such as Internet services.

A SEPP 126 filters incoming traffic from another PLMN and can perform topology hiding for traffic exiting the home PLMN. SEPP 126 may communicate with a SEPP in a foreign PLMN which manages security for the foreign PLMN. Thus, traffic between NFs in different PLMNs may traverse two SEPP functions, one for the home PLMN and the other for the foreign PLMN. A SEPP filtering egress messages from consumer NFs in a PLMN is referred to as a consumer SEPP or C-SEPP. A SEPP that filters ingress messages directed to producer NFs in a PLMN is referred to as a producer SEPP or P-SEPP. A given SEPP can function as a C-SEPP and a P-SEPP, depending on the role the SEPP is performing.

A unified data repository (UDR) 128 stores subscription data for UEs. A binding support function (BSF) 130 manages bindings between PDU sessions and PCFs.

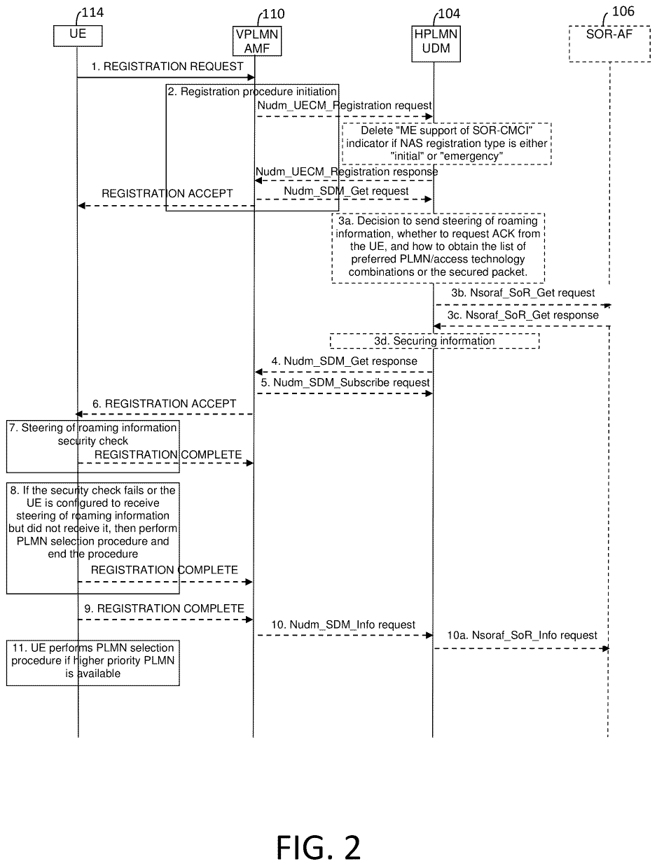

As indicated above, problems that can occur in communication networks include unnecessary signaling and loss of revenue by a non-preferred VPLMN when an HPLMN steers a UE to attach to another VPLMN. Steering of roaming can occur during or after initial UE registration. FIG. 2 is a message flow diagram illustrating exemplary messages exchanged for steering of roaming during initial UE registration. Referring to FIG. 2, in step 1, UE 114 sends an initial registration request to VPLMN AMF 110. VPLMN AMF 110 receives the initial registration request, and, in step 2, initiates the UE registration procedure by sending an Nudm_UECM_UE_Registration request to HPLMN UDM 104. HPLMN UDM 104 receives the Nudm_UECM_UE_Registration request, and, in response, deletes the ME support of SOR-CMCI indicator if the network access stratum (NAS) registration type is either “initial” or “emergency”. HPLMN UDM 104 sends a Nudm_UECM_Registration response to VPLMN AMF 110. If VPLMN AMF 110 does not have subscription data for the UE, VPLMN AMF 110 sends an Nudm_UECM_Get request to HPLMN UDM 104 to obtain access and mobility information for the UE. If steering of roaming is not being performed, VPLMN AMF 110 sends a registration accept message to UE 114.

In step 3a, HPLMN UDM 104 determines that steering of roaming is being performed and starts the process of obtaining the steering of roaming information for the UE. In step 3b, HPLMN UDM 104 sends an Nsoraf_SoR_Get request message to SOR AF 106 to obtain steering of roaming information for the UE. SOR-AF 106 receives the Nsoraf_SoR_Get request, obtains the list of preferred PLMN/access technology combinations and the ME supports SOR-CMCI indicator and provides the SoR information to HPLMN UDM 104 in an NsorafSor_Get response in step 3c. In step 3d, The HPLMN UDM forms the steering of roaming information as specified in 3GPP TS 33.501 from:
the list of preferred PLMN/access technology combinations, the SOR-CMCI, if any, and the “Store SOR-CMCI in ME” indicator, if any, or the secured packet obtained in step 3a; or
the list of preferred PLMN/access technology combinations and the SOR-CMCI, if any, and “Store the SOR-CMCI in ME” indicator, if any, or the secured packet, obtained in step 3c.
   In step 4, HPLMN UDM 104 sends the steering of roaming information to VPLMN AMF 110 in an Nudm_SDM_Get response message. In step 5, VPLMN AMF 110 invokes the Nudm_SDM_Subscribe service operation with HPLMN UDM 104 to subscribe to receive notification of changes to the subscription data received in step 4, including updates to the steering of roaming information.

In step 6, VPLMN AMF 110 sends a registration accept message including the steering of roaming information to UE 114. In step 7, UE 114 performs a security check of the steering of roaming information. If HPLMN UDM 104 has not requested an acknowledgement from UE 114, then UE 114 sends a registration complete message from VPLMN AMF 110 without including an SOR transparent container.

In step 8, if the security check fails for the steering of roaming information or if the UE is configured to receive steering of roaming information but did not receive the steering of roaming information, UE 114 performs PLMN selection and sends a registration complete message to VPLMN AMF 110.

In step 9, if HPLMN UDM 104 requested an acknowledgement, UE 114 sends a registration complete message including the acknowledgement to VPLMN AMF 110. In step 10, VPLMN AMF 110 sends an Nudm_SDM_Info request to HPLMN UDM 104 to provide the SOR transparent container received in the registration complete message to HPLMN UDM 104. In step 10a, HPLMN UDM 104 informs SOR-AF 106 of successful delivery of the steering of roaming information to UE 114. In step 11, UE 114 performs PLMN selection as indicated by the steering of roaming information.

If VPLMN AMF 110 is associated with a non-preferred VPLMN of the HPLMN, UE 114 may be steered to register with another PLMN. As a result, the registration-related signaling messages in FIG. 2 unnecessarily waste the processing resources of the PLMN of VPLMN AMF 110. Moreover, the PLMN of VPLMN AMF 110 loses the revenue associated handling communications with UE 114.

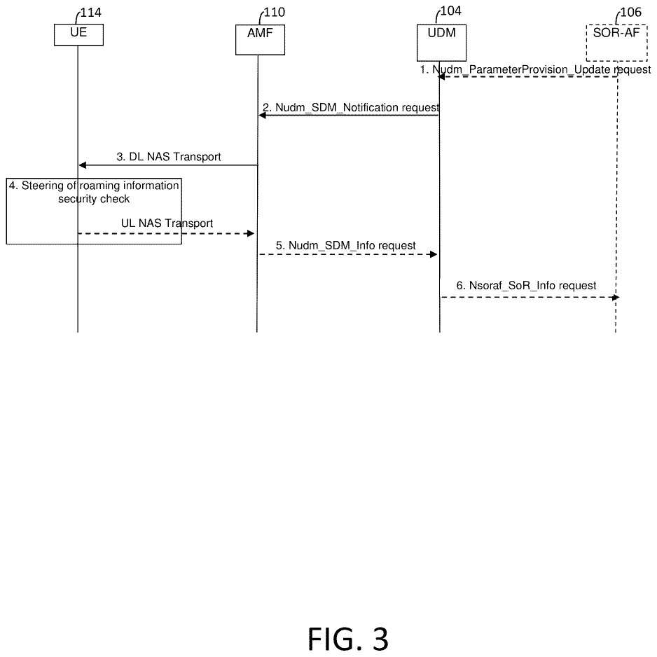

In addition to delivering steering of roaming information to a UE during initial registration, steering of roaming information can be delivered post registration. FIG. 3 is a message flow diagram illustrating the delivery of steering of roaming information to a UE after registration. Referring to FIG. 3, in step 1, SoR AF 200 sends an Nudm_ParameterProvision_Update request to UDM 104 to trigger the sending of updated SoR information to the UE. In step 2, UDM 104 sends an Nudm_SDM_Notification request with the updated steering of roaming information to AMF 110. In step 3, AMF 110 sends downlink (DL) NAS transport information to UE 114 including the updated steering of roaming information received from UDM 104. In step 4, UE 114 receives the updated steering of roaming information and performs a security check of the SoR information. If the security check is successful, UE 114 stores the updated steering of roaming information and may use the updated steering of roaming information to attached to a new preferred PLMN.

If UDM 104 requested any acknowledgement from the UE in the DL NAS transport message, UE 114 sends the acknowledgment to AMF 110 in an uplink (UL) NAS transport message. In step 5, AMF 110 sends an Nudm_SDM_info request message including the acknowledgement to UDM 104. In step 6, UDM 104 sends an Nsoraf_SoR_Info request to SoR-AF 106 informing SoR-AF 106 of successful receipt of the SoR information by UE 114.

During or after UE registration, the HPLMN may perform the steering of roaming based on different parameters. Examples of parameters that may be used for steering of roaming include:
VPLMN Id
% of roaming traffic per VPLMN
# of VPLMN Ids in a given roaming country
Time of day
Location of the roaming subscriber
UE device type (based on PEI/IMEI)
Slice Id requested
Access (3GPP vs Non-3GPP) & Radio Network Type (4G LTE, 5G NR, NR Satellite, etc.)
Outbound roaming subscriber's subscription plans (QoS, etc.)
   Control plane steering logic at the HPLMN may vary based on the roaming agreement between each individual VPLMN and the HPLMN. SoR AF call processing logic behavior that implements each steering of roaming agreement is not transparent to VPLMN operators. A non-preferred VPLMN operator does not have insight into the SoR policies of the HPLMN that would enable the non-preferred VPLMN operator to have a new roaming partner agreement with the HPLMN or update an existing roaming partner agreement with the HPLMN and generate new or additional roaming revenue by avoiding steering UEs towards another VPLMN operator.

SBI signaling occurs between the VPLMN and the HPLMN during UE registration from a non-preferred VPLMN towards the HPLMN before the UE is steered towards a preferred VPLMN due to control plane HPLMN SoR policies. This means that additional processing is required at 5G core NFs in the non-preferred VPLMN for a roaming UE that is eventually steered to another VPLMN. There is also a cost for a non-preferred VPLMN for inter-PLMN SBI signaling to be paid to IP exchange (IPX) providers for a roaming UE which will eventually get steered to another VPLMN operator due to control plane SoR.

The subject matter described herein addresses these challenges by automatically deriving HPLMN steering of roaming policies at a network analytics platform, such as a 3GPP network data analytics function (NWDAF) or other network analytics platform and a proxy function, making the policies accessible to the proxy function, such as a SEPP or an SCP, and taking action to avoid steering UEs away from the VPLMN based on the derived policies. The network analytics platform may be a standalone platform or co-located with a network function, including, but not limited to the proxy function. In one example the SCP or SEPP feeds SBI signaling to the network analytics platform for outbound roaming subscribers during and after registration procedures. The network analytics platform creates, based on the SBI signaling, a dataset record with the following labeled features/columns derived from SBI signaling:

### Input Features:

Timestamp: Date and time of UE registration initiation. This allows an AI-ML model to derive the dependency of HPLMN SoR policies on time
VPLMN Id: Allows identification of the SoR policies based on VPLMN Ids
HPLMN Id of inbound roaming subscriber: Allows identification of the SoR policies for a given HPLMN
IMSI/SUPI of inbound roaming subscriber: Allows identification of the SoR policies dependent on a specific subscriber. This is an optional input and can be ignored if the network operator does not want to have a model to determine SoR policies at the individual subscriber level.
PEI/IMEI of inbound roaming subscriber: Helps identify the SoR policies dependent on UE device type.
Location of inbound roaming subscriber - TAC Id: Allows SoR based on location of the roaming subscriber.
S-NSSAI: Requested network slice Id. Allows determination of SoR based on slice Ids.
Access Type: Allows determination of SoR policies based on access type.
Radio Type—Allows determination of SoR policies based on radio type.

### Output:

Preferred network, i.e., no steering (0)
Non-preferred network, i.e., steer to other VPLMN (1)
Thus, using the parameters listed above, the VPLMN SEPP or SCP can query the analytics platform based on roaming signaling for an outbound roaming subscriber/UE, obtain an indication as to whether the UE will be steered to another network, and take appropriate action, such as blocking a registration message associated with registration of the UE.

In one example, the following inter-PLMN SBI messages between a VPLMN AMF and an HPLMN UDM may be forwarded by the SCP or SEPP to the analytics platform and used to derive the input and output labeled features during a UE registration procedure for a given outbound roaming subscriber to build a single record:
Nudm UE CM Registration & De-Registration Request and Response
Nudm SDM Get Request and Response
Nudm SDM info request and response
   The above-described data may be collected for a time period, such as one or more months, to create the labeled dataset with the above-described features. The labeled dataset may be used to train an AI/ML model at the analytics platform to derive the SoR policies of the HPLMN, which may be based on % traffic threshold per VPLMN. The analytics platform may use a classification ML model (such as a deep learning AI classification model trained using supervised learning) s or a supervised classification models) to predict whether a given outbound roaming subscriber will be steered to another VPLMN. For example, a recurrent neural network (RNN) deep learning model, such as a long short term memory (LSTM) model, may be used due to the dependency of steering of roaming predictions on timestamp data and time sequencing. An appropriate ML model may be selected by training different models to predict steering of roaming decisions, evaluating the trained models using a different data set from the training dataset, and selecting the trained model with the highest SoR prediction accuracy score as the model to use in predicting steering of roaming decisions for particular roaming subscribers/UEs. In one example, the models can be evaluated and selected in an automated ML model selection processing pipeline.

After training, testing, and selecting the SoR prediction model, the following actions may occur at the VPLMN:
1. The VPLMN SCP/SEPP may interrogate the analytics platform using parameters from UE CM registration signaling from the AMF towards the HPLMN and determine if the current UE will be steered to another VPLMN of the HPLMN. The analytics platform uses the trained model to determine a predicted steering of roaming decision for the UE and provides an indication to the SCP/SEPP as to whether the UE will be steered to another PLMN. If the output from the analytics platform indicates that the UE will be steered to another PLMN, the SCP/SEPP may reject a UE CM registration message with a configurable error code back to the AMF rather than continuing with UE registration and later steering the UE to a different preferred PLMN of the HPLMN.
2. The proposed solution can be used to create periodic roaming insight reports per HPLMN to understand the roaming SoR policies followed by different operators. These insights can be used by the operator of a VPLMN to negotiate with the operator of the HPLMN for better roaming partner agreements with different operators and also update the network infrastructure to avoid steering more roaming traffic towards other PLMN networks.
3. ML model training may be performed intermittently based on a dataset created from SCP/SEPP traffic feed at the network analytics platform based on configuration to avoid data drift and model decay conditions.
   More simplified variants of models can also be created based on receiving a new UE CM registration request at the SCP/SEPP and using the models to allow/reject the registration request.

The following are examples of simple SoR policies that may be derived and used to predict a steering of roaming decision for a UE:

Example #1 (Steer based on # of devices per VPLMN Id):
Input:
   HPLMN Id
   Current number of UEs registered successfully in the current month/last X number of days (based on roaming agreement followed by operators)
Output:
   Steered (0)
   Not Steered (1)
      Example #2: (Steer based on location)
Input:
   HPLMN Id
   Current number of UEs registered successfully in the current

month/last X number of days (based on roaming agreement followed by operators) in specific TAI or list of TAI
Output:
   Steered (0)
   Not Steered (1)
      Example #3: (Steer based on access and radio type)
Input:
   HPLMN Id
   Current number of UEs registered successfully in the current month/last X number of days (based on roaming agreement followed by operators for specific access and radio type
   Access Type
   Radio Type
Output:
   Steered (0)
   Not Steered (1)

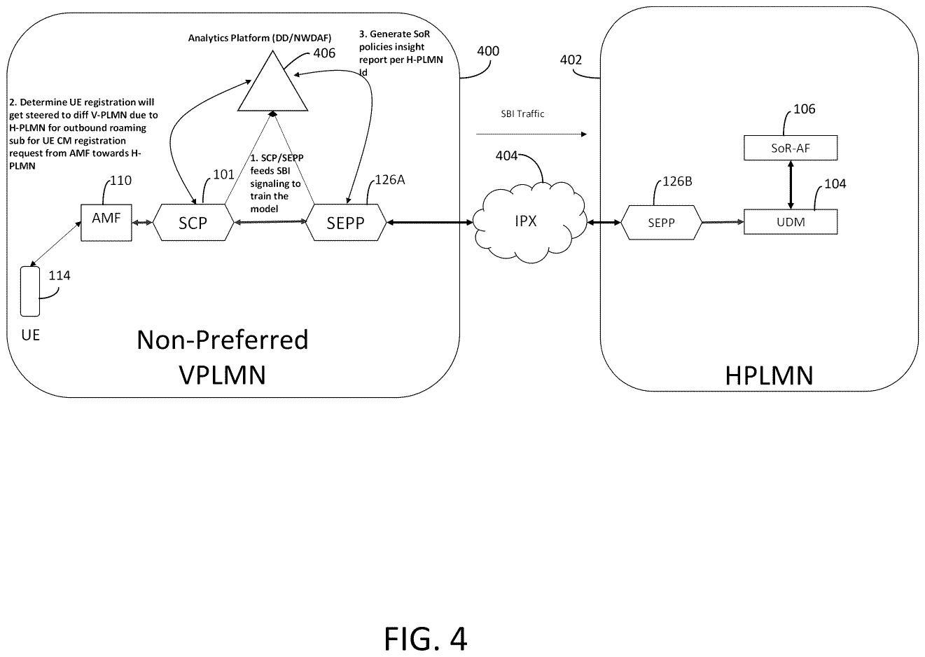

FIG. 4 is a network diagram illustrating an exemplary architecture for automatically deriving and using a steering of roaming policy. Referring to FIG. 4, SBI signaling for the outbound roaming subscriber is sent from a non-preferred VPLMN 400 to an HPLMN 402 via IPX provider network 404. SCP 101 and/or SEPP 126A in non-preferred VPLMN 400 feed roaming SBI signaling traffic to an ML model implemented on network analytics platform 406 to train the model to predict whether a given UE will be steered to a PLMN other than non-preferred PLMN 400 based on parameters from SBI signaling messages, including UE CM registration messages and post-registration messages, such as those described above with respect to FIGS. 2 and 3. Once the model is trained, when SCP 101 or SEPP 126A receives a new SBI signaling message from AMF 110 relating to UE 114, SCP 101 or SEPP 126A sends a query message to network analytics platform 406. The query message may include a copy of the SBI signaling message received from AMF 110 and/or parameters from the signaling message. Network analytics platform 406 receives the query message, inputs the message parameters to the model, generates an indication of whether UE 114 will be steered to a PLMN other than non-preferred VPLMN 400, and transmits the indication to the query originator (SCP 101 or SEPP 126A) in a response message to the query message. SCP 101 or SEPP 126A receives the response message and reads the indication as to whether UE 114 will be steered to another VPLMN. If SCP 101 or SEPP 126A determines that UE 114 will be steered to another VPLMN, SCP 101 or SEPP 126A may block the SBI message and send an error response to AMF 110. If SCP 101 or SEPP 126A determines that UE 114 will not be steered to another PLMN, SCP 101 or SEPP 126A may forward the SBI signaling message to HPLMN 402 via IPX 404 and SEPP 126B. Network analytics platform 406 may also generate SoR policy insight reports per HPLMN Id so that the operator of non-preferred VPLMN 400 can use the reports to the occurrences of UEs being steered to other PLMNs to negotiate new roaming agreements with the operator of HPLMN 402 and/or upgrade VPLMN 400 to reduce the likelihood of subscribers being steered to another VPLMN.

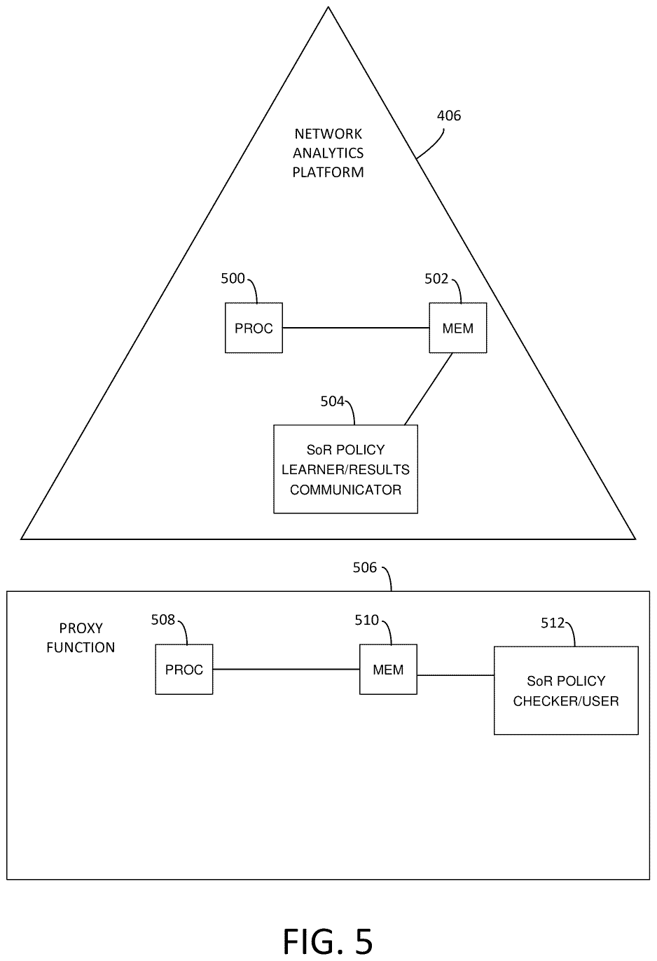

FIG. 5 is a block diagram illustrating an exemplary architecture of a network analytics platform and a proxy function for automatically deriving and using a steering of roaming policy. Referring to FIG. 5, network analytics platform 406 includes at least one processor 500 and a memory 502. Network analytics platform 406 further includes an SoR policy determiner/results communicator 504 for learning/deriving steering of roaming policies of other PLMNs and communicating predicted SoR decision results to a proxy function 506, which may be an SCP or an SEPP. Proxy function 506 also includes at least one processor 508 and memory 510. Proxy function 506 further includes an SoR policy checker/user 512 for receiving SBI signaling messages relating to outbound roaming subscribers, obtaining predicted SoR decisions from SoR policy determiner/results communication 504, and using the predicted SoR decisions to determine whether to allow or block SBI signaling messages. SoR policy determiner/results communicator 504 and SoR policy checker/user 512 may be implemented using computer executable instructions stored, respectively in memories 502 and 510 and executed by processors 500 and 508. It should also be noted that, as described above, network analytics platform 406 can be co-located with proxy function 506, in which case SoR policy determiner/results communicator 504 and SoR policy checker/user 512 may execute on the same processor or group of processors.

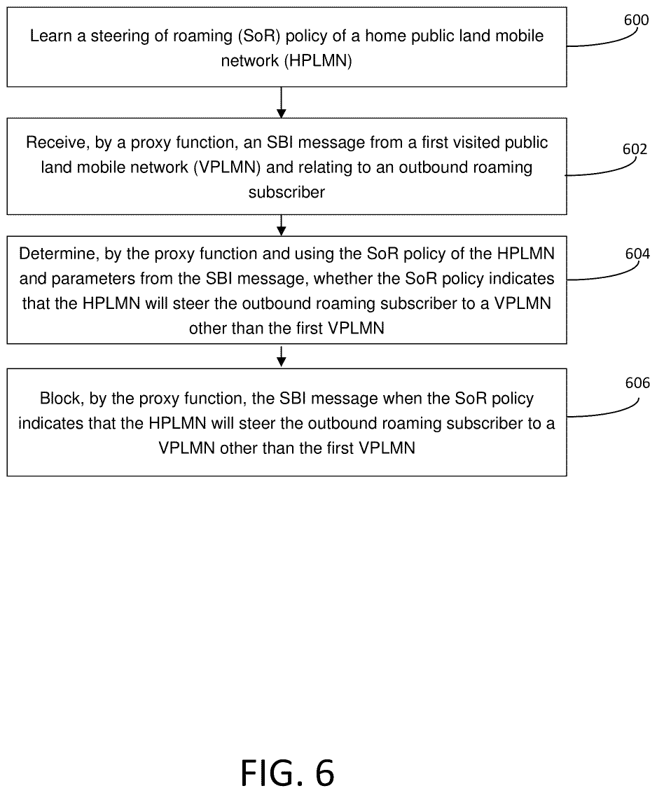

FIG. 6 is a flow chart illustrating an exemplary process for automatically deriving and using a steering of roaming policy of a home PLMN. Referring to FIG. 6, in step 600, the process includes learning a steering of roaming (SoR) policy of a home public land mobile network (HPLMN). For example, SoR policy determiner/results communicator 504 may learn a steering of roaming policy of an HPLMN by training an AI/ML model using SBI signaling relating to outbound roaming subscribers of the HPLMN and corresponding steering of roaming decisions of the HPLMN. The steering of roaming decisions, i.e., whether or not a subscriber was steered to a VPLMN, may also be derived from the SBI signaling. Examples of such SBI signaling and corresponding roaming decisions are described above.

In step 602, the process further includes receiving, by a proxy function, an SBI message from a first visited public land mobile network (VPLMN) and relating to an outbound roaming subscriber. For example, a proxy function, such as an SCP or an SEPP, may receive an SBI message that relates to a subscriber of a home PLMN who is roaming in a VPLMN. The message may be a registration message or a post-registration SBI message.

In step 604, the process further includes determining, by the proxy function and using the steering of roaming policy for the HPLMN and parameters from the SBI message, whether the policy indicates that the HPLMN will steer the outbound roaming subscriber to a VPLMN other than the first VPLMN. For example, a proxy function, such as an SCP or an SEPP may determine that the subscriber will be steered to another VPLMN by sending a query message to SoR policy determiner/results communicator 504 including parameters from the received SBI request message and receive a response indicating whether or not the subscriber will be steered to another VPLMN.

In step 606, the process further includes blocking, by the proxy function, the SBI message when the policy indicates that the HPLMN will steer the outbound roaming subscriber to a VPLMN other than the first VPLMN. For example, a proxy function, such as an SCP or an SEPP, may block an SBI request message relating to an outbound roaming subscriber when the steering of roaming policy indicates that the outbound roaming subscriber will be steered to another VPLMN.

Exemplary advantages of the subject matter described herein include reducing unnecessary signaling between a non-preferred VPLMN and a preferred VPLMN when the non-preferred VPLMN determines that an outbound roaming subscriber will be steered to the preferred VPLMN and blocks the signaling associated with the steering of roaming. Another advantage of the subject matter described herein may be increased revenue at a VPLMN by reducing the volume of traffic that is steered to another VPLMN. The subject matter described herein allows a VPLMN mobile network operator (MNO) to negotiate with an operator of the HPLMN as an preferred MNO for improved roaming revenue. The subject matter described herein allows a non-preferred VPLMN operator to infer HPLMN SoR AF behavior of steering the roaming traffic based on different factors, such as traffic steering per VPLMN, time of day, location, roaming subscriber profile (e.g., quality of service (QoS)), etc., and then allow/block UE registration of an outbound roaming subscriber. The VPLMN can negotiate new or updated roaming partner agreements with the HPLMN based on the information generated by the subject matter described herein. The subject matter described herein also enables a non-preferred VPLMN operator to upgrade the network or fine tune network parameters, which can avoid steering of subscribers towards other VPLMN operators, by understanding the SoR policies of the HPLMN and making network upgrades to avoid SoR. The subject matter described herein avoids unnecessary additional registration related inter-PLMN SBI signaling from a non-preferred VPLMN to the HPLMN by blocking/rejecting UE CM registration at SCP/SEPP using SoR analytics data. The subject matter reduces VPLM operating costs by reducing payments to IP exchange providers for additional inter-PLMN SBI signaling which otherwise would have steered another VPLMN MNO during later call processing procedures involving a UE. The subject matter described herein avoids additional processing at NFs in a non-preferred VPLMN related to registration related SBI processing by blocking registration up front at the SCP or SEPP.

The disclosure of each of the following references is hereby incorporated herein by reference in its entirety.

### REFERENCES

1. 3^{rd} Generation Partnership Project; Technical Specification Group Core Network and Terminals; 5G System; Network Function Repository Services; Stage 3 (Release 19) 3GPP TS 29.510 V19.0.0 (2024-09)
2. 3^{rd} Generation Partnership Project; Technical Specification Group Core Network and Terminals; Non-Access Stratum (NAS) functions related to Mobile Station (MS) in idle mode (Release 19) 3GPP TS 23.122 V 18.8.0 (2024-09)
3. 3^{rd} Generation Partnership Project; Technical Specification Group Services and System Aspects; Procedures for the 5G System (5GS); Stage 2 (Release 18) 3GPP TS 23.502 V 19.2.0 (2024-09)
4. 3^{rd} Generation Partnership Project; Technical Specification Group Services and System Aspects; Security architecture and procedures for 5G system (Release 19) 3GPP TS 33.501 V 19.0.0 (2024-09)

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for automatically deriving and using a steering of roaming (SoR) policy, the method comprising:
learning a steering of roaming (SoR) policy of a home public land mobile network (HPLMN);
receiving, by a proxy function, an SBI message from a first visited public land mobile network (VPLMN) and relating to an outbound roaming subscriber;
determining, by the proxy function and using the SoR policy for the HPLMN and parameters from the SBI message, whether the SoR policy indicates that the HPLMN will steer the outbound roaming subscriber to a VPLMN other than the first VPLMN; and
blocking, by the proxy function, the SBI message when the SoR policy indicates that the HPLMN will steer the outbound roaming subscriber to a VPLMN other than the first VPLMN.

2. The method of claim 1 wherein learning the SoR policy of the HPLMN includes learning the SoR policy from SBI message feeds from the HPLMN.

3. The method of claim 1 wherein learning the SoR policy includes training a machine learning model to predict whether an outbound roaming subscriber will be steered to a VPLMN other than the first VPLMN.

4. The method of claim 1 wherein learning the SoR policy used by the HPLMN includes learning the SoR policy at a network analytics platform.

5. The method of claim 4 determining, by the proxy function whether the SoR policy indicates that the HPLMN will steer the outbound roaming subscriber to a VPLMN other than the first VPLMN includes querying, by the proxy function, the network analytics platform and receiving a response from the network analytics platform indicating whether or not the outbound roaming subscriber will be steered to a VPLMN other than the first VPLMN.

6. The method of claim 4 wherein learning the SoR policy at the network analytics platform includes learning the SoR policy at a network data analytics function (NWDAF).

7. The method of claim 4 wherein learning the SoR policy at the network analytics platform includes learning the SoR policy at a stand-alone network analytics platform or a network analytics platform that is co-located with a network function.

8. The method of claim 4 wherein learning the SoR policy at the network analytics platform includes learning the SoR policy using a training dataset that includes data indicating numbers of UEs steered to particular VPLMNs, radio access types, time parameters, UE identifying parameters, network slice identifying parameters, network identifying parameters, UE locations, and corresponding SoR decisions.

9. The method of claim 1 the proxy function comprises a service communication proxy (SCP).

10. The method of claim 1 wherein the proxy function comprises a security edge protection proxy (SEPP).

11. A system for automatically deriving and using a steering of roaming (SoR) policy, the system comprising:
an SoR policy determiner/results communicator for learning an SoR policy of a home public land mobile network (HPLMN); and
a proxy function including at least one processor and a memory for receiving an SBI message from a first visited public land mobile network (VPLMN) and relating to an outbound roaming subscriber, determining, using the SoR policy for the HPLMN and parameters from the SBI message, whether the SoR policy indicates that the HPLMN will steer the outbound roaming subscriber to a VPLMN other than the first VPLMN, and blocking the SBI message when the SoR policy indicates that the HPLMN will steer the outbound roaming subscriber to a VPLMN other than the first VPLMN.

12. The system of claim 11 wherein the SoR policy determiner/results communicator is configured to learn the SoR policy from SBI message feeds from the HPLMN.

13. The system of claim 11 wherein the SoR policy determiner/results communicator is configured to learn the SoR policy by training a machine learning model to predict whether an outbound roaming subscriber will be steered to a VPLMN other than the first VPLMN.

14. The system of claim 11 comprising a network analytics platform wherein the SoR policy determiner/results communicator is implemented on the network analytics platform.

15. The system of claim 14 wherein the proxy function is configured to determine whether the SoR policy indicates that the HPLMN will steer the outbound roaming subscriber to a VPLMN other than the first VPLMN by querying the network analytics platform and receiving a response from the network analytics platform indicating whether or not the outbound roaming subscriber will be steered to a VPLMN other than the first VPLMN.

16. The system of claim 14 wherein the network analytics platform comprises a network data analytics function (NWDAF).

17. The system of claim 14 wherein the network analytics platform comprises a stand-alone network analytics platform or a platform that is integrated or co-located with a network function.

18. The system of claim 14 wherein the network analytics platform is configured to learn the SoR policy using a training dataset that includes data indicating numbers of UEs steered to particular VPLMNs, radio access types, time parameters, UE identifying parameters, network slice identifying parameters, network identifying parameters, UE locations, and corresponding SoR decisions.

19. The system of claim 11 wherein the proxy function comprises a service communication proxy (SCP) or a security edge protection proxy (SEPP).

20. A non-transitory computer readable medium having stored thereon executable instructions that when executed by a processor of a computer control the computer to perform steps comprising:
learning a steering of roaming (SoR) policy of a home public land mobile network (HPLMN);
receiving, by a proxy function, an SBI message from a first visited public land mobile network (VPLMN) and relating to an outbound roaming subscriber;
determining, by the proxy function and using the SoR policy of the HPLMN and parameters from the SBI message, whether the SoR policy indicates that the HPLMN will steer the outbound roaming subscriber to a VPLMN other than the first VPLMN; and
blocking, by the proxy function, the SBI message when the SoR policy indicates that the HPLMN will steer the outbound roaming subscriber to a VPLMN other than the first VPLMN.
